(19) United States
(12) Patent Application Publication
(10) Pub. No.: US 2026/0287086 A1
(43) Pub. Date: Sep. 24, 2026

(54) SYSTEMS AND METHODS FOR REDUNDANT AUTO-SWAPPING VALVE POSITIONERS

(71) Applicants: Inventus Holdings, LLC, Juno Beach, FL (US); Florida Power & Light Company, Juno Beach, FL (US)

(72) Inventor: Ronald V. Byrd, Port St. Lucie, FL (US)

(21) Appl. No.: 19/083,005

(22) Filed: Mar. 18, 2025

(51) Int. Cl. F16K 37/00; F16K 31/06

(52) U.S. Cl. CPC F16K 37/0083; F16K 31/0675

(57) ABSTRACT

The disclosed technology relates generally to systems and methods for mitigating valve-related single point vulnerabilities. The disclosed technology includes a system including a first valve positioner and a second valve positioner, both connected to a valve actuator of a valve. The first valve positioner includes an on-board diagnostic system configured to generate an alert. The system includes a positioner swapping system configured to redirect an input pressure of the valve actuator from the first valve positioner to the second valve positioner. The input pressure of the valve actuator is redirected based at least in part on the alert generated by the on-board diagnostic system.

### FIELD OF TECHNOLOGY

The disclosed technology relates generally to redundant valve positioners, and, more particularly, to systems and methods for swapping redundant valve positioners of air-operated valves.

### BACKGROUND

Power plants in operation can have mechanisms, structures, components, etc. referred to as single point vulnerabilities (SPVs). SPVs, upon failure, can individually cause an outage or failure of the power plant. As can be appreciated, mitigating single point vulnerabilities is a top priority of power plant management and, in many scenarios, one or more fail-safes are applied to an SPV to ensure that if the SPV component fails, a backup component may come online to prevent an outage.

A traditional system for preventing an outage of a power plant includes redundant valves and corresponding redundant valve positioners for valves with critical functions. Redundancy, as understood in the art, provides a backup component for a primary component such that the backup component is connected to the same input and output lines as the primary component, yet operates individually. In this way, the backup component can be automatically swapped for the primary component if the primary component fails, without causing an interruption of a function of the valve.

Traditional redundant valve positioners are connected to the distributed control system (DCS) of the power plant. Thus, installing the redundant valve positioners requires an outage of the plant, which, as can be appreciated, may be very costly for the power plant manager. Further, redundant valve positioners connected to the DCS can primarily be maintained offline, or during an outage of the power plant, which incurs further costs to the power plant manager.

What is needed, therefore, is a system and method for mitigating valve-related single point vulnerabilities without requiring an outage of the power plant during installation and/or maintenance. These and other advantages of the presently-disclosed technology will become apparent throughout the following disclosure.

### BRIEF SUMMARY

To achieve the above-described method for mitigating valve-related single point vulnerabilities, the disclosed technology includes a system for mitigating valve-related single point vulnerabilities. The system can include a first valve positioner. The first valve positioner can be connected to a valve actuator of a valve. The first valve positioner can include an on-board diagnostic system configured to generate an alert. The system can include a second valve positioner, the second valve positioner being connected to the valve actuator. The system can include a positioner swapping system configured to redirect an input pressure of the valve actuator from the first valve positioner to the second valve positioner.

According to another aspect of the present disclosure, the disclosed technology includes a system for mitigating valve-related single point vulnerabilities. The system can include a valve actuator configured to operate a valve. The system can include a first valve positioner connected to the valve actuator. The first valve positioner can be configured to alter valve travel of the valve. The first valve positioner can include a first on-board diagnostic system configured to generate a first alert. The system can include a second valve positioner connected to the valve actuator. The second valve positioner can be configured to alter valve travel of the valve. The second valve positioner can include a second on-board diagnostic system configured to generate a second alert. The system can include a positioner swapping system. The positioner swapping system can include a solenoid valve configured to swap an input pressure of the valve actuator from the first valve positioner to the second valve positioner based at least in part on at least one of the first alert and the second alert.

The disclosed technology can additionally include a method for mitigating valve-related single point vulnerabilities. The method can include generating an alert signal from an on-board diagnostic system of one of a primary valve positioner and a backup valve positioner. The primary valve positioner and the backup valve positioner can be connected to a valve actuator of a valve. The method can include redirecting an input pressure of the valve actuator from one of the primary valve positioner and the backup valve positioner to the other of the primary valve positioner and the backup valve positioner based at least in part on the alert signal.

### BRIEF DESCRIPTION OF THE DRAWINGS

The accompanying drawings, which are incorporated in and constitute a part of this specification, illustrate various aspects of the presently disclosed subject matter and serve to explain the principles of the presently disclosed subject matter. The drawings are not intended to limit the scope of the presently disclosed subject matter in any manner.

FIG. 1 illustrates a system for mitigating valve-related single point vulnerabilities, in accordance with examples of the present disclosure.

FIG. 2 illustrates a system for mitigating valve-related single point vulnerabilities, in accordance with examples of the present disclosure.

FIG. 3 illustrates a system for mitigating valve-related single point vulnerabilities, in accordance with examples of the present disclosure.

FIG. 4 illustrates a system for mitigating valve-related single point vulnerabilities, in accordance with examples of the present disclosure.

FIG. 5 illustrates a system for mitigating valve-related single point vulnerabilities, in accordance with examples of the present disclosure.

FIG. 6 is a flow diagram of a method for mitigating valve-related single point vulnerabilities, in accordance with examples of the present disclosure.

FIG. 7 is another flow diagram of a method for mitigating valve-related single point vulnerabilities, in accordance with examples of the present disclosure.

### DETAILED DESCRIPTION

The disclosed technology relates generally to systems and methods for mitigating valve-related single point vulnerabilities. Unlike existing systems which rely on a DCS of the power plant to monitor valves and communicate alerts of a valve system, the disclosed technology employs a novel system and method of generating valve-related alerts from on-board diagnostic systems. In this way, the disclosed technology can be configured such that the disclosed technology can operate independently of the plant DCS and allow for online maintenance of valves for the power plant.

The disclosed technology can include redundant valve positioners, or referred to herein as a first valve positioner and a second valve positioner. As can be appreciated, the first valve positioner and the second valve positioner can be both configured to operate a valve actuator of a valve. In some embodiments, the valve actuator can be pneumatically operated, such that the valve actuator can be configured to receive an input pressure from the first valve positioner and/or the second valve positioner. Further, the first valve positioner and the second valve positioner can each generate a pneumatic output based on a single control signal which indicates to the valve positioner what the desired degree of openness, or desired valve travel, is for the valve at any given moment in time. As can be appreciated, due to system error, component error, mechanical failure, etc., the desired valve travel communicated to the first and/or second valve positioner may deviate from the valve travel being measured at the valve. This deviation, or “travel deviation,” can ultimately cause a system failure if the valve is a single point vulnerability, and thus there is motivation to mitigate this potential failure without causing an outage of the entire system, which can be expensive. Systems and methods of the disclosed technology can include a positioner swapping system that can be configured to affect which of the first valve positioner and the second valve positioner contribute to the input pressure of the valve actuator, or stated otherwise, which valve positioner’s pneumatic output is reaching the valve actuator and operating the valve actuator. As will be discussed in greater detail herein, the positioner swapping system can include one or more mechanisms configured to automatically trigger upon the generation of an alert (e.g., a travel deviation) by an on-board diagnostic system of one of the valve positioners.

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways. In particular, the presently disclosed subject matter is described in the context of systems and methods for mitigating valve-related single point vulnerabilities. The present disclosure, however, is not so limited, and can be applicable in other contexts such as systems and methods used for mitigating single point vulnerabilities for other purposes such as academic and industrial purposes. Accordingly, when the present disclosure is described in the context of systems and methods of mitigating single point vulnerabilities, it will be understood that other implementations can take the place of those referred to herein.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

The components described hereinafter as making up various elements of the disclosed technology are intended to be illustrative and not restrictive. Many suitable components that would perform the same or similar functions as the components described herein are intended to be embraced within the scope of the disclosed technology. Such other components not described herein can include, but are not limited to, similar components that are developed after development of the presently disclosed subject matter.

As used herein, the term “redundant” or “redundancy” can include a primary component and a secondary component, such that the secondary component can be configured to perform the function of the primary component in the event that the primary component fails or goes offline. As non-limiting examples, valve positioners for valves can be redundant, such that redundant valve positioners can include at least a first valve positioner, and a second valve positioner connected to a common valve.

As used herein, the term “online” can include a characterization of a power plant, or a portion thereof, being in active operation. As non-limiting examples, online can include “online maintenance” which, as can be appreciated, can include maintenance of one or more components, systems, or elements while the power plant is in operation.

Accordingly, as used herein, the term “outage” can include a characterization of a power plant, not being in active operation. As non-limiting examples, an outage can be caused by a reactor trip, which may be caused by a component failure, instrumentation error, safety system actuation, external events, human error, etc. As can be appreciated, an outage for a power plant can be very costly, and thus may occur at planned, or periodical, time intervals. As a non-limiting example, an outage can be cause by a failure of a single point vulnerability.

As used herein, the term “single point vulnerability” or “SPV” can include any element or component of a system in which a failure would incur a failure (and/or outage) of the system as a whole. As non-limiting examples, an SPV can include a feedwater regulating valve of a nuclear plant, a main feedwater regulating valve, or any critical valve that can directly cause a reactor trip and/or outage.

As used herein, the term “valve positioner” or “positioner” can include any device configured to control opening and closing a valve actuator of a valve. Valve positioners can be connected to a valve and receive a control signal to determine a degree to which the valve will be opened or closed. As non-limiting examples, valve positioners can be actuated via pneumatic, electro-pneumatic, digital (smart), or similar means as understood by those skilled in the art.

As used herein, the term “on-board diagnostic system” or “on-board diagnostics” can include a built-in system for a component of systems discussed herein configured to monitor component performance and detect performance issues. As a non-limiting example, on-board diagnostics can be an on-board diagnostic system of a valve positioner configured to monitor at least a valve travel of the valve positioner. As will be discussed herein, some examples of the on-board diagnostic system can be configured to generate a signal, sometimes referred to herein as an “alert” or “alert signal,” that can be based on a comparison of the valve travel of the valve positioner to the control signal received by the valve positioner.

As used herein, the term “valve travel” can include an indicator of an extent of a valve being open or closed. As a non-limiting example, valve travel can be described as a percentage of a total flux area that is open. As can be appreciated, valve travel of a valve can be controlled, or altered, by a valve positioner connected to the valve.

As used herein, the term “travel deviation” can include a measure of a difference between a control signal supplied to a valve positioner and valve travel of a valve of the valve positioner. As a non-limiting example, travel deviation can be a percentage difference between the control signal and the valve travel, in that the control signal can be representative of a desired valve travel and the valve travel can be representative of actual valve travel. In other examples, travel deviation can include any examples of control feedback as understood for similar contexts of systems and methods discussed herein. As can be appreciated, travel deviation can lead to a valve failing to operate.

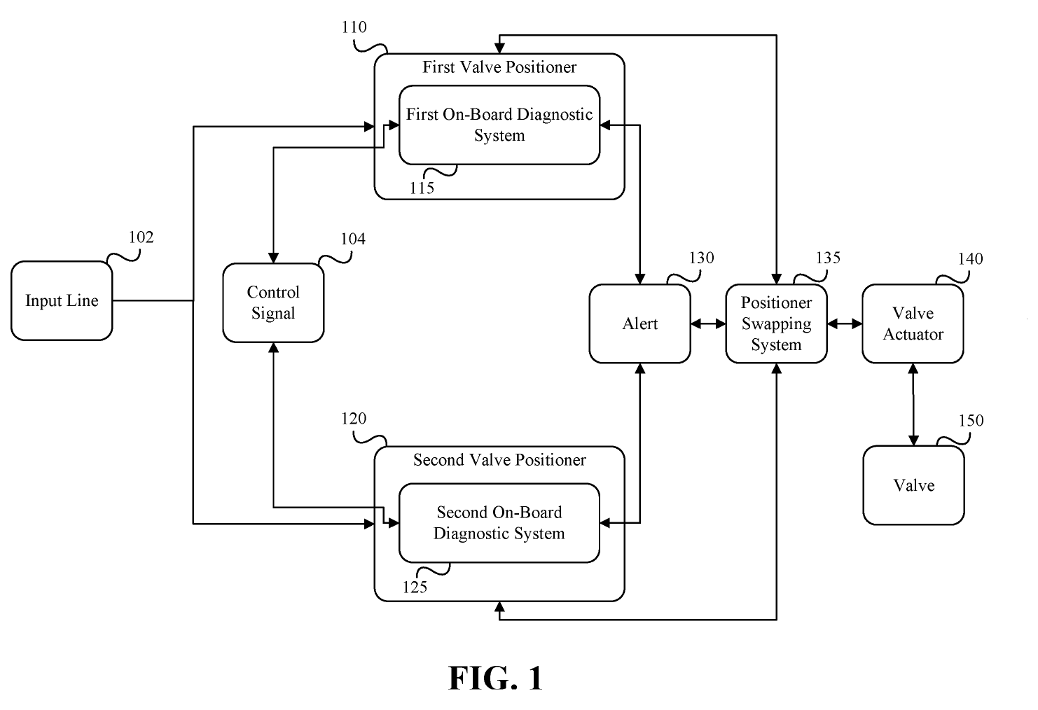

Referring now to the drawings, in which like numerals represent like elements, the present disclosure is herein described. FIG. 1 illustrates a system 100 that can be configured to mitigate valve-related single point vulnerabilities. As will become apparent throughout this disclosure, the system 100 (as well as other examples described herein) can be used for swapping redundant valve positioners without requiring an outage for installation or maintenance.

Systems and methods of the disclosed technology (e.g., the system 100) can be configured for use within a power plant. That is, the system 100 can be configured to be implemented into a power plant based at least in part on the systems and methods for mitigating valve-related single point vulnerabilities discussed herein. For example, the system 100, or any systems discussed herein, can be configured to operate within a nuclear power plant. In other examples, the system 100, or any systems discussed herein, can be configured to operate within a hydroelectric plant, battery energy storage system (BESS), fossil fuel plant, solar power plant, wind power plant, biomass power plant, geothermal power plant, or any power plants of similar contexts including components corresponding to implementations of the disclosed technology. Additionally, systems and methods of the disclosed technology (e.g., the system 100) can be configured for use in any site with air operated valves, such paper mills, oil refineries, chemical plants, pharmaceutical plants, food and beverage processing plants, water and wastewater plants, automotive manufacturing facilities, mining sites, and the like. That is, as used herein, the term “power plant” can include any site including valves for which systems and methods of the disclosed technology can be configured for use.

As can be appreciated, embodiments of the disclosed technology, such as system 100, can be configured to be implemented into existing systems of the power plant. For example, the system 100 can be configured to be implemented into existing input lines, output lines, valves, or any combination thereof of the power plant. In other examples, the system 100 can include an input line, one or more valves, or any combination thereof, as will be discussed in greater detail herein.

The system 100 can include an input line 102 configured to provide a fluid input to the system 100. In some embodiments, the input line 102 can be configured to provide air to one or more components of the system 100. Stated otherwise the input line 102 can be configured to provide a pneumatic input to the system 100. As will be discussed in greater detail herein, the pneumatic input from the input line 102 can be used by one or more valve positioners to operate a valve actuator of a valve. In some embodiments, the input line 102 can include a metal pipe or a hose depending on the fluid input. That is, the input line can include steel, copper, PVC, HDPE, rubber, plastic, glass, concrete, or any other materials used for the context of transporting fluids.

The system 100 can include a first valve positioner 110 configured to control a valve travel of a valve 150. The first valve positioner 110 can be in fluid communication with the input line 102, such that the first valve positioner 110 can be configured to receive a pneumatic input from the input line 102. The first valve positioner 110 can be connected to a valve actuator 140 configured to open and close (or actuate) the valve 150. That is, the first valve positioner 110 can be configured to open, at least partially, and close the valve 150 via the valve actuator 140. Further, as discussed herein, a degree of opening and closing a valve can be described by a valve travel. In this way, the first valve positioner 110 can be configured to alter a valve travel of the valve 150.

The first valve positioner 110 can be described as controlling or non-controlling. The first valve positioner 110 can be described as controlling if the pneumatic output of the first valve positioner 110 is contributing to the input pressure of the valve actuator 140. Similarly, the first valve positioner 110 can be described as non-controlling if the pneumatic output of the first valve positioner 110 is not contributing to the input pressure of the valve actuator 140. Stated otherwise, the first valve positioner 110 can be controlling when a flow path from the first valve positioner 110 to the valve actuator 140 is open, and the first valve positioner can be non-controlling when a flow path from the first valve positioner 110 to the valve actuator 140 is blocked, or obstructed. In this way, the input pressure of the valve actuator 140 can be redirected from the first valve positioner 110 by transitioning the first valve positioner 110 from being controlling to being non-controlling.

In some embodiments, the first valve positioner 110 can be a pneumatic valve positioner. That is, the first valve positioner 110 can be pneumatically pressurized and electrically operated. As discussed herein, the first valve positioner 110 can be configured to receive the pneumatic input from the input line 102. As understood by those skilled in the art, the first valve positioner 110 can be configured to produce a pneumatic output based at least in part on the desired valve travel. That is, the pneumatic output of the first valve positioner 110 can vary based at least in part on the desired valve travel of the valve 150. Stated otherwise, the first valve positioner 110 can be configured to transition between being controlling and non-controlling based at least in part on an electrical input and a pneumatic pressure.

The first valve positioner 110 can be configured to receive a control signal 104 indicating a desired valve travel for the valve 150. Stated otherwise, the control signal 104 can include instructions configured to cause the first valve positioner 110 to set, or alter, the degree of opening of the valve 150. In some embodiments, the control signal 104 can contain instructions indicative of whether the first valve positioner 110 is to fully open, partially open, fully close, or partially close. In this way, the control signal 104 can be configured to cause the first valve positioner 110 to transition between being controlling and non-controlling. The control signal 104, in some embodiments, can be in the form of a percentage, such that the control signal 104 can include a percentage for the desired valve travel for the valve 150. In comparisons made to other values of percentage herein, the control signal 104 can be characterized as the percentage of the desired valve travel for the valve 150 that is provided to the first valve positioner 110. That is, the valve travel of the valve 150 may deviate from the desired valve travel of the control signal 104. This deviation, as will be discussed herein, can be referred to herein as a travel deviation.

Although not shown, the control signal 104 can be communicated to the first valve positioner 110 via a controller. The controller can include any device, as understood by those skilled in the art, configured to send, either automatically or via manual input, a signal (e.g., the control signal 104) to define an operation of a component of the system 100, such as the first valve positioner 110.

The valve 150 can be an air-operated valve, such that the valve 150 can be configured to open and close, at least partially, based on air pressure, referred to herein as an input pressure. In some embodiments, the input pressure can be supplied to the valve actuator 140, such that the valve actuator 140 may be configured to open and close the valve 150 via the input pressure. That is, the input pressure, as used herein, can be the input pressure of the valve actuator 140. As understood herein, the valve 150 can be an air-operated valve due to the valve actuator 140 being air-operated, or being configured to actuate based at least in part on the pneumatic input from the input line 102. In some embodiments, the valve 150 can include a feedwater regulating valve, or main feedwater regulating valve, configured to maintain a programmed water level in an associated steam generator. Additionally, the valve 150 can include any air-operated valve with a critical function, or SPV. As can be appreciated, the valve 150 can be a single point vulnerability of a power plant, in that the system 100 can be configured to mitigate valve-related single point vulnerabilities for the power plant by mitigating a single point vulnerability associated with at least the valve 150.

The first valve positioner 110 can include a first on-board diagnostic system 115 configured to monitor the first valve positioner 110. In some examples, the first on-board diagnostic system 115 can monitor the control signal 104 received by the first valve positioner 110 and the valve travel (or actual valve travel) of the valve 150. The first on-board diagnostic system 115 can monitor the valve travel of the valve 150 with a sensor or a device of similar contexts as understood by those skilled in the art. Further, the first on-board diagnostic system 115 can be configured to detect a travel deviation of the valve 150. In this way, the first on-board diagnostic system 115 can be configured to compare the valve travel of the valve 150 to the control signal 104 received by the first valve positioner 110 to detect a travel deviation. As can be appreciated, the travel deviation, when detected by the first on-board diagnostic system 115, can be associated with the first valve positioner 110, such that the travel deviation can be indicative of an issue with the first valve positioner 110. As understood by those skilled in the art, a travel deviation of a valve positioner (e.g., the first valve positioner 110) can indicate that the valve positioner, and thus the connected valve (e.g., the valve 150), could be at risk of failure, or is not operating properly. As will be discussed in greater detail herein, the first on-board diagnostic system 115 can be configured to communicate a travel deviation of the first valve positioner 110 to a component of the system 100 and cause the input pressure of the valve actuator 140 to be redirected from the first valve positioner 110 to another component, such as another valve positioner.

The first on-board diagnostic system 115 can be configured to generate an alert 130. The alert 130 can be a signal generated by the first on-board diagnostic system 115 indicative of a potential failure of the first valve positioner 110, the valve actuator 140, and/or the valve 150. As discussed herein, a travel deviation of the first valve positioner 110 trigger an alert, such that the first on-board diagnostic system 115 can generate the alert 130 when a travel deviation is detected over a predetermined duration of time. The alert 130 may be referred to as an “alert signal”, as can be appreciated, such that the alert 130 may be communicated to a component of the system 100 via an electrical, wireless, digital, or other signals as understood within the contexts described herein. The alert 130 can be generated by the first on-board diagnostic system 115 based at least in part on user defined parameters of the first on-board diagnostic system 115. Stated otherwise, the first on-board diagnostic system 115 can be setup, or enabled, with one or more user defined parameters which may define conditions for triggering the alert 130. For example, the alert 130 can be a travel deviation alert, and the user defined parameters of the first on-board diagnostic system 115 can include a predetermined travel deviation threshold for a predetermined duration of time to determine when to trigger, or output, the alert 130. In some embodiments, the predetermined travel deviation threshold can include any percentage from 0% to 150%, and the predetermined duration of time can include any duration of time from 0.1 seconds to 420 seconds, such that the first on-board diagnostic system 115 can be configured to automatically output the alert 130 (or an alert signal) based at least in part on any combination of examples of the predetermined travel deviation threshold and the predetermined duration of time discussed herein. The alert 130 can be communicated by the first on-board diagnostic system 115 in such a way that the alert 130 can cause the input pressure of the valve actuator 140 to be directed away from the first valve positioner 110.

The system 100 can include a second valve positioner 120 connected to the valve actuator 140 of the valve 150 and configured to receive the fluid input from the input line 102. The second valve positioner 120 can include any embodiments of the first valve positioner 110 discussed herein. That is, the second valve positioner 120 can be configured to receive the pneumatic input from the input line 102, receive the control signal 104 indicative of the desired valve travel for the valve 150, receive the pneumatic input, produce a pneumatic output which may vary in degree based at least in part on the desired valve travel, etc. In this way, the first valve positioner 110 and the second valve positioner 120 can be redundant valve positioners, such that the second valve positioner 120 can be configured to perform a function of the first valve positioner 110 if the first valve positioner 110 were to fail or come offline. Stated otherwise, the first valve positioner 110 can be a primary valve positioner, and the second valve positioner 120 can be a backup valve positioner. In some embodiments, during typical operation of the power plant, the first valve positioner 110 can be controlling and the second valve positioner 120 can be non-controlling. Stated otherwise, the second valve positioner 120 can be configured to be on standby for the first valve positioner 110 when the power plant is online. Alternatively, if the first valve positioner 110 fails, the system 100 can be configured to redirect the input pressure of the valve actuator 140 from the first valve positioner 110 to the second valve positioner 120.

Redirecting the input pressure of the valve actuator 140 from the first valve positioner 110 to the second valve positioner 120 or from the second valve positioner 120 to the first valve positioner 110, as understood herein, can include determining which pneumatic output of the first valve positioner 110 or the second valve positioner 120 is to be used as the input pressure for the valve actuator 140. Stated otherwise, the input pressure received by the valve actuator 140 can either be from the pneumatic output of the first valve positioner 110 or the second valve positioner 120. That is, redirecting the input pressure of the valve actuator 140 from one valve positioner to another valve positioner (e.g., from the first valve positioner 110 to the second valve positioner 120 or from the second valve positioner 120 to the first valve positioner 110) can be understood herein as swapping the source of the input pressure of the valve actuator 140 from one valve positioner to another valve positioner. As will be discussed in greater detail herein, the system 100 can include a component, element, mechanism, or the like configured to redirect the input pressure of the valve actuator 140 from one of the first valve positioner 110 and the second valve positioner 120 to the other of the first valve positioner 110 and the second valve positioner 120.

The first valve positioner 110 and the second valve positioner 120 can be referred to herein as being “controlling” or “non-controlling.” As understood by those skilled in the art, a controlling valve positioner has a pneumatic output that is directed towards the valve actuator 140 and is used as the input pressure for the valve actuator 140. Similarly, a non-controlling valve positioner has a pneumatic output that is directed away from the valve actuator 140 and is not used as the input pressure for the valve actuator 140. In some embodiments, a controlling valve positioner can have a flow path connected to the valve actuator 140 such that the pneumatic output of the controlling valve can reach the valve actuator 140. Alternatively, a non-controlling valve positioner can have a flow path be disconnected, or obstructed, from the valve actuator 140 such that the pneumatic output of the non-controlling valve may not reach the valve actuator 140.

In this way, redirecting the input pressure can be understood herein as (1) establishing a flow path between the valve actuator 140 and one of the first valve positioner 110 and the second valve positioner 120, such that the pneumatic output of said valve positioner contributes to the input pressure of the valve actuator 140, and (2) obstructing a flow path between the valve actuator 140 and the other of the first valve positioner 110 and the second valve positioner 120, such that the pneumatic output of said valve positioner does not contribute to the input pressure of the valve actuator 140. For example, redirecting the input pressure of the valve actuator 140 from the first valve positioner 110 to the second valve positioner 120 can include directing the pneumatic output of the first valve positioner 110 away from the valve actuator 140 and directing the pneumatic output of the second valve positioner 120 towards the valve actuator 140 such that the pneumatic output of the second valve positioner 120 can contribute to the input pressure of the valve actuator 140. Similarly, redirecting the input pressure of the valve actuator 140 from the first valve positioner 110 to the second valve positioner 120 can include directing the pneumatic output of the second valve positioner 120 away from the valve actuator 140 and directing the pneumatic output of the first valve positioner 110 towards the valve actuator such that the pneumatic output of the first valve positioner 110 can contribute to the input pressure of the valve actuator 140.

The second valve positioner 120 can be configured to receive the control signal 104. As can be appreciated, the second valve positioner 120 may be non-controlling while still receiving the control signal 104. That is, if the first valve positioner 110 becomes non-controlling, or the input pressure of the valve actuator 140 is redirected from the first valve positioner 110 to the second valve positioner 120, the second valve positioner 120 can be configured to alter the valve travel of the valve 150 via the valve actuator 140 based at least in part on the control signal 104.

The second valve positioner 120 can include a second on-board diagnostic system 125 configured to monitor the second valve positioner 120. The second on-board diagnostic system 125 can include any embodiments of the first on-board diagnostic system 115, such that the second on-board diagnostic system 125 can be configured to monitor the valve travel of the valve 150 and compare the valve travel of the valve 150 to the desired valve travel of the control signal 104. The second on-board diagnostic system 125 can be configured to generate the alert 130. As can be appreciated, the alert 130, when generated by the second on-board diagnostic system 125, can include any embodiments of the alert 130 discussed herein. That is, the second on-board diagnostic system 125 can be configured to detect a travel deviation of the second valve positioner 120 and generate the alert 130 based at least in part on the travel deviation.

The system 100 can include a positioner swapping system 135 configured to receive the alert 130 from the first on-board diagnostic system 115 and/or the second on-board diagnostic system 125. The positioner swapping system 135 can be configured to cause the input pressure of the valve actuator 140 to be redirected from the first valve positioner 110 to the second valve positioner 120 or the second valve positioner 120 to the first valve positioner 110. In some embodiments, the first valve positioner 110 can be the primary valve positioner and the second valve positioner 120 can be the backup valve positioner, such that the positioner swapping system 135 can receive the alert 130 from the first on-board diagnostic system 115 and redirect, based on the alert 130, the input pressure of the valve actuator 140 from the first valve positioner 110 (the primary valve positioner) to the second valve positioner 120 (the backup valve positioner). As will be discussed in greater detail herein, the redirecting of the input pressure of the valve actuator 140 (sometimes referred to herein as “swapping”) from the first valve positioner 110 to the second valve positioner 120 can be automatically executed by the positioner swapping system 135. That is, the positioner swapping system 135 can be configured to redirect the input pressure of the valve actuator 140 from the second valve positioner 120 back to the first valve positioner 110. In some embodiments, the positioner swapping system 135 can redirect the input pressure of the valve actuator 140 from the second valve positioner 120 to the first valve positioner 110 if the second on-board diagnostic system 125 of the second valve positioner 120 generates an alert (e.g., the alert 130). As can be appreciated, the positioner swapping system 135 can be pneumatically and- electrically connected to the first valve positioner 110, second valve positioner 120, and the valve actuator 140 such that the positioner swapping system 135 may be configured to receive the alert 130 and swap the input pressure of the valve actuator 140 between the first valve positioner 110 and the second valve positioner 120. In some embodiments, the positioner swapping system 135 can be configured to alter flow paths of the first valve positioner 110 and the second valve positioner 120, in that the positioner swapping system 135 can be configured to connect and obstruct flow paths of the first valve positioner 110 and the second valve positioner 120 to and from the valve actuator 140. In this way, the positioner swapping system 135 can be configured to allow the pneumatic output of the first valve positioner 110 and the pneumatic output of the second valve positioner 120 to contribute to the input pressure of the valve actuator 140, and obstruct the pneumatic output of the first valve positioner 110 and the pneumatic output of the second valve positioner 120 from contributing to the valve actuator 140. In some embodiments, the positioner swapping system 135 can connect a flow path of one of the first valve positioner 110 and the second valve positioner 120 to the valve actuator 140 and direct a flow path of the other of the first valve positioner 110 and the second valve positioner 120 away from the valve actuator 140.

As discussed herein, the system 100 can include the valve actuator 140 configured to operate the valve 150. In some embodiments, the valve actuator 140 can be pneumatically actuated, in that the valve actuator 140, as discussed herein, can be configured to actuate the valve 150 based at least in part on the input pressure. As can be appreciated, the valve actuator 140 can be configured to receive the input pressure from the input line 102, the first valve positioner 110, the second valve positioner 120, or any combination thereof.

As discussed herein, the system 100 can include the valve 150. The valve 150, as understood by those skilled in the art, can include a feedwater regulating valve of a power plant, a feedwater regulating valve of a nuclear plant, or any air-operated valve with a critical function (e.g., an SPV valve) of a power plant, industrial plant, or any example sites as understood herein. The valve 150, as discussed herein, can be coupled to the valve actuator 140 such that the valve actuator 140 can be configured to operate the valve 150. As understood by those skilled in the art, the valve actuator 140 can be configured to operate the valve 150 by being configured to open, close, and throttle the valve 150. The valve 150 can be an air-operated valve, in that the valve 150 can be configured to be actuated by the valve actuator 140 which can be actuated based at least in part on the input pressure, the input pressure being the pneumatic output from one of the first valve positioner 110 and the second valve positioner 120.

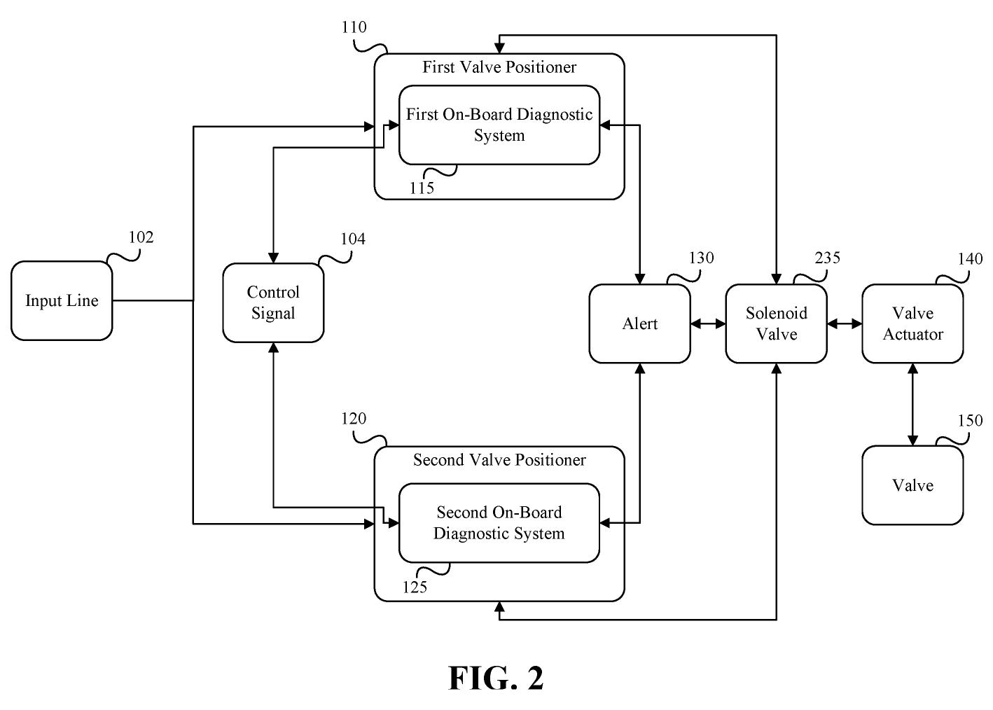

FIG. 2 illustrates a system 200 for mitigating valve-related single point vulnerabilities. As shown, the system 200 can include the input line 102, the control signal 104, the first valve positioner 110, the first on-board diagnostic system 115, the second valve positioner 120, the second on-board diagnostic system 125, the alert 130, the valve actuator 140, and the valve 150. Additionally, the system 200 can include a solenoid valve 235 configured to swap the input pressure of the valve actuator 140 between the first valve positioner 110 and the second valve positioner 120 based at least in part on the alert 130. The solenoid valve 235, as understood by those skilled in the art, can include any mechanism including a solenoid and configured to actuate and de-actuate based on an energy input, for example, electric power. For example, the solenoid valve 235 can include a powered (or energized) state and an unpowered (or de-energized) state characterized by whether the solenoid valve 235 is receiving power. In some embodiments, the solenoid valve 235 can be configured to actuate in the energized state and de-actuate in the de-energized state. Stated otherwise, the solenoid valve 235 can be configured to actuate upon being powered. Alternatively, as can be appreciated, the solenoid valve 235 can be configured to actuate upon being de-energized, in that the solenoid valve 235 can be configured to actuate when the solenoid valve 235 is no longer receiving an energy input.

The solenoid valve 235 can be in electrical communication with the first valve positioner 110 and/or the second valve positioner 120, such that the solenoid valve 235 may be configured to receive the alert 130 from at least one of the first valve positioner 110 and the second valve positioner 120. The solenoid valve 235 can be in fluid communication with the first valve positioner 110 and the second valve positioner 120, in that the solenoid valve 235 can be configured to receive the pneumatic output from the first valve positioner 110 and the pneumatic output from the second valve positioner 120. Further, the solenoid valve 235 can be in fluid communication with the valve actuator 140, such that the solenoid valve 235 can be configured to direct the input pressure to the valve actuator 140. In this way, the solenoid valve 235 can be configured to redirect the input pressure of the valve actuator 140 from one of the first valve positioner 110 and the second valve positioner 120 to the other of the first valve positioner 110 and the second valve positioner 120.

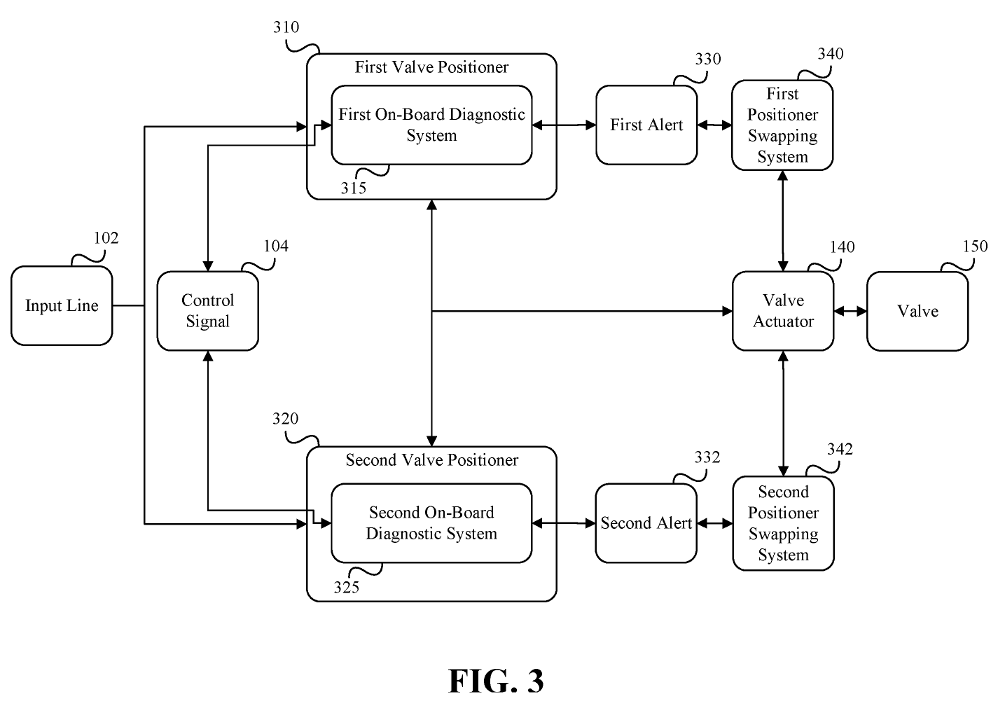

FIG. 3 illustrates a system 300 for mitigating valve-related single point vulnerabilities. As shown, the system 300 can include the input line 102, the valve actuator 140, and the valve 150. Additionally, the system 300 can include a first valve positioner 310 connected to the input line 102. The first valve positioner 310 can include any embodiments of the first valve positioner 110 discussed herein. For example, the first valve positioner 310 can be configured to alter the valve travel of the valve 150 via providing a pneumatic input to the valve actuator 140 as the input pressure for the valve actuator 140. As can be appreciated, the first valve positioner 310 can include a first on-board diagnostic system 315 configured to monitor the first valve positioner 310. The first on-board diagnostic system 315 can include any embodiments of the first on-board diagnostic system 115 discussed herein. The first valve positioner 310 can be configured to receive the control signal 104.

The first on-board diagnostic system 315 can be configured to generate a first alert 330. The first alert 330 can include any embodiments of the alert 130 discussed herein, such that the first alert 330 can be generated by the first on-board diagnostic system 315 based on an alert for the first valve positioner 310. For example, the first alert 330 can be a travel deviation alert, such that the first alert 330 can be generated based at least in part on a travel deviation of the valve 150 when the input pressure of the valve actuator 140 is the pneumatic output of the first valve positioner 310.

The system 300 can include a first positioner swapping system 340 configured to receive the first alert 330 from the first on-board diagnostic system 315 of the first valve positioner 310. The first positioner swapping system 340 can include any embodiments of the positioner swapping system 135 discussed herein, such that the first positioner swapping system 340 can be configured to redirect the input pressure of the valve actuator 140 from one of the first valve positioner 310 and the second valve positioner 320 to the other of the first valve positioner 310 and the second valve positioner 320. In some embodiments, the first positioner swapping system 340 can be configured to allow and prevent the pneumatic output of the first valve positioner 310 from reaching the valve actuator 140. That is, the first positioner swapping system 340 can be configured to prevent the pneumatic output from contributing to the input pressure of the valve actuator 140 based at least in part on the first alert 330.

In a non-limiting example embodiment, if the first on-board diagnostic system 315 detects an alert triggering situation (e.g., a travel deviation), the first on-board diagnostic system 315 can automatically generate the first alert 330 and communicate the first alert 330 in the form of an electric signal to the first positioner swapping system 340. In a continued non-limiting example embodiment, a component of the first positioner swapping system 340 (e.g., a solenoid valve such as the solenoid valve 235) can automatically close upon receiving the first alert 330, causing the pneumatic output of the first valve positioner 310 to no longer be communicated to the valve actuator 140.

The system 300 can include a second valve positioner 320 connected to the input line 102. The second valve positioner 320 can include any embodiments of the second valve positioner 120 discussed herein. For example, the second valve positioner 320 can be connected to the valve actuator 140 and configured to alter the valve travel of the valve 150.

The second valve positioner 320 can include a second on-board diagnostic system 325 configured to monitor the second valve positioner 320. The second on-board diagnostic system 325 can include any embodiments of the second on-board diagnostic system 125 discussed herein. The second valve positioner 320 can be configured to receive the control signal 104.

The second on-board diagnostic system 325 can be configured to generate a second alert 332. The second alert 332 can include any embodiments of the alert 130 discussed herein, such that the second alert 332 can be generated by the second on-board diagnostic system 325 based on an alert for the second valve positioner 320. For example, the second alert 332 can be a travel deviation alert, such that the second alert 332 can be generated based at least in part on a travel deviation of the valve 150 when the input pressure of the valve actuator 140 is the pneumatic output of the second valve positioner 320.

The system 300 can include a second positioner swapping system 342 configured to receive the second alert 332 from the second on-board diagnostic system 325. The second positioner swapping system 342 can include any embodiments of the positioner swapping system 135 discussed herein, such that the second positioner swapping system 342 can be configured to redirect the input pressure of the valve actuator 140 from one of the first valve positioner 310 and the second valve positioner 320 to the other of the first valve positioner 310 and the second valve positioner 320. In some embodiments, the second positioner swapping system 342 can be configured to allow and prevent the pneumatic output of the second valve positioner 320 from reaching the valve actuator 140. That is, the second positioner swapping system 342 can be configured to prevent the pneumatic output from contributing to the input pressure of the valve actuator 140 based at least in part on the second alert 332.

In some embodiments, the first positioner swapping system 340 and the second positioner swapping system 342 can be both used to redirect the input pressure of the valve actuator 140 from the first valve positioner 310 to the second valve positioner 320. For example, the first positioner swapping system 340 can actuate upon receiving the first alert 330 and block the pneumatic output of the first valve positioner 310 to the valve actuator 140, and the second positioner swapping system 342 can be configured to actuate and allow the pneumatic output of the second valve positioner 320 to become the input pressure for the valve actuator 140. As can be appreciated, the first positioner swapping system 340 and the second positioner swapping system 342, like the positioner swapping system 135, can include a valve (e.g., a solenoid valve) configured to open and close to allow and prevent, respectively, the pneumatic output of the first valve positioner 310 and/or the second valve positioner 320 to contribute to the input pressure of the valve actuator 140.

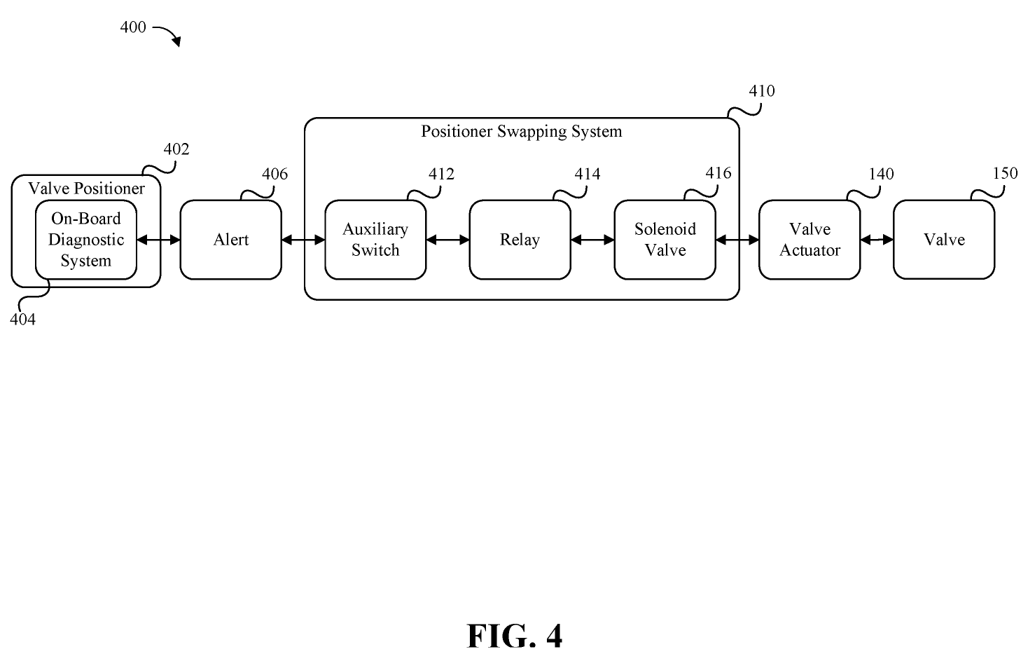

FIG. 4 illustrates a system 400 for mitigating valve-related single point vulnerabilities. The system 400 can include the valve actuator 140 and the valve 150. Additionally, the system 400 can include a valve positioner 402, which can be one of the first valve positioner 110, the first valve positioner 310, the second valve positioner 120, and the second valve positioner 320. As can be appreciated, the valve positioner 402 can include an on-board diagnostic system 404, which can be one of the first on-board diagnostic system 115, the first on-board diagnostic system 315, the second on-board diagnostic system 125, and the second on-board diagnostic system 325 depending on the valve positioner 402. The on-board diagnostic system 404 can be configured to generate an alert 406, which can be one of the alert 130, the first alert 330, and the second alert 332.

The system 400 can include a positioner swapping system 410, which can be one of the positioner swapping system 135, the first positioner swapping system 340, and the second positioner swapping system 342 depending on the valve positioner 402. That is, the positioner swapping system 410 can be configured to redirect an input pressure of the valve actuator 140 from the valve positioner 402 to another valve positioner, or from another valve positioner to the valve positioner 402. The first positioner swapping system 340 can include an auxiliary switch 412 configured to open upon receipt of the alert 405. Stated otherwise, the auxiliary switch 412 can be configured to automatically open based at least in part on the alert 406. In this way, the alert 406 may trigger the auxiliary switch 412 to open, such that the auxiliary switch 412 can be configured to transition from a closed state to an open state if the auxiliary switch 412 receives an alert signal (e.g., the alert 406). As can be appreciated, the auxiliary switch 412 can be a normally open type switch, a normally closed type switch, a discrete switch, a changeover type switch, or any type of switch used for similar contexts as understood by those skilled in the art. That is, the auxiliary switch 412 can be configured to close upon receiving the alert 406, such that the auxiliary switch 412 can be configured to transition from an open state to a closed state if the auxiliary switch 412 received an alert signal.

In some examples, the auxiliary switch 412 can be part of one or more auxiliary switches configured to receive one or more alerts, or alert signals. Stated otherwise, the auxiliary switch 412 can be part of multiple auxiliary switches, such that the multiple auxiliary switches can be configured to trigger, at least indirectly, one or more valve positioners to transition between being controlling and non-controlling. That is, each auxiliary switch of the multiple auxiliary switches can be associated with one of a plurality of alert types. For example, one auxiliary switch of the multiple auxiliary switches can be associated with a travel deviation alert, another auxiliary switch can be associated with, travel sensor failure, loss of power, or alerts of similar contexts as understood herein. Stated otherwise, an alert triggering situation can include a travel deviation, travel sensor failure, loss of power, etc. In this way, the system 400, and any embodiments of systems and methods of the disclosed technology discussed herein, can be configured to communicate one or more alerts, via an alert signal, to at least one auxiliary switch, such that the at least one auxiliary switch can cause, at least indirectly, the system 400 to swap an input pressure of the valve actuator 140 from a primary valve to a secondary valve.

The positioner swapping system 410 can include a relay 414 in communication with the auxiliary switch 412. The relay 414 can include a latching relay, a k-relay, or any similar relay as understood herein. Although not shown, the relay 414 can include a coil, such that the coil is configured to be de-energized based upon the state of the auxiliary switch 412. In some examples, the relay 414 can be configured to de-energize the coil when the auxiliary switch 412 is open. In this way, the relay 414 can be de-energized based at least in part on the alert 204. Stated otherwise, the auxiliary switch 412 can be configured to de-energize the relay 414 if the auxiliary switch 412 receives an alert signal. As can be appreciated, the relay 414 may include a single coil latching relay, a dual coil latching relay, or any combination thereof. That is, the relay 414 can include multiple coils configured to be de-energized based at least in part on one or more alert signals received by one or more auxiliary switches. As understood in the art, a k-relay can be configured to return to a default state after an actuating input is removed. For example, the actuating input can be electric power received via the opening or closing of the auxiliary switch 412, such that the k-relay can be configured to actuate upon receiving the electric power and de-actuate upon removal of the electric power. Stated otherwise, the k-relay may need continuous power to maintain position. Alternatively, as understood in the art, the relay 414 include a latching relay configured to maintain actuation after removal of the electric power and may require a second signal to transition back to a de-actuated state. Stated otherwise, the relay 414 can maintain its position (on or off) without requiring continuous power to a coil of the relay 414.

The relay 414 can be a first relay, such that the positioner swapping system 410 can include at least a second relay. The second relay can include any example relays discussed herein. In some embodiments, the first relay can be associated with a first valve positioner (e.g., the first valve positioner 110 or the first valve positioner 310) and the second relay can be associated with a second valve positioner (e.g., the second valve positioner 120 or the second valve positioner 320). For example, the first relay can be a part of the first positioner swapping system 340 and the second relay can be a part of the second positioner swapping system 342. In this way, the first relay can be configured to affect the flow path of the first valve positioner and the second relay can be configured to affect the flow path of the second valve positioner. As can be appreciated, the first relay and the second relay can include any combination of relays as discussed herein. As a non-limiting example, the first relay can be a latching relay and the second relay can be a k-relay, such that de-energizing a coil of the first relay can cause the input pressure of the valve actuator 140 to swap from the first valve positioner to the second valve positioner, and the de-energizing of the second relay can cause the input pressure of the valve actuator 140 to swap from the second valve positioner to the first valve positioner.

The positioner swapping system 410 can include a solenoid valve 416 in communication with the relay 414. As can be appreciated, the solenoid valve 416 can be the solenoid valve 235. In this way, any embodiments of the positioner swapping system 135, the first positioner swapping system 340, and the second positioner swapping system 342 discussed herein can include a solenoid valve, such as the solenoid valve 416. The solenoid valve 416 can include any examples of solenoids, solenoid valves, or mechanisms of similar contexts as understood by those skilled in the art. For example, the solenoid can include a positioner swapping solenoid configured to redirect an input pressure of the valve actuator 140 from a first valve positioner to a second valve positioner, as understood herein. In some examples, the solenoid valve 416 can be actuated electrically. The solenoid valve 416, in some examples, can be configured to be actuated based at least in part on a powered state and non-powered state, such that the solenoid of the solenoid valve 416 can actuate upon transitioning from the non-powered state to the powered state. Stated otherwise, the solenoid valve 416 can be configured to actuate, as understood in the art, upon receiving a power signal. In some examples, as understood in the art, the power signal can include a 120 volt alternating current (VAC) signal, a 120 volt direct current signal (VDC), a 24 VAC signal, a 24 VDC signal, or similar signals for contexts of the solenoid valve 416 understood herein. As a non-limiting example, a 120 VAC signal can be used to actuate the solenoid valve 416, a 24 VDC signal can be used to actuate the relay 414, and 4-20 mA DC current can be used to operate the valve positioner 402. In some examples, the solenoid valve 416 can be in electrical communication with the relay 414, such that the relay 414 can be configured to actuate the solenoid valve 416. Alternatively, the solenoid valve 416 can be configured to be actuated when the coil of the relay 414 is de-energized. In this way, the solenoid valve 416 can be configured to redirect the input pressure of the valve actuator 140 from a first positioner to a second positioner based at least in part on the alert 406 generated by the on-board diagnostic system 404.

Although not shown, the positioner swapping system 410 can further include instrument valves configured to bypass the solenoid valve 416. For example, the instrument valves can include a 3-way instrument valve system that can be configured, similar to the solenoid valve 416, to align the output of the valve positioner 402 with the valve actuator 140.

In some examples, the solenoid valve 416 can be part of a redundant valve positioner system, such that the solenoid valve 416 can be one of multiple solenoids of the redundant valve positioner system. The multiple solenoids, in some examples, can be each coupled to a valve positioner in such a way that each solenoid can be configured to alter a flow path of the pneumatic output of the valve positioner. Alternatively, the solenoid valve 416 can be in communication with multiple valve positioners (e.g., the first valve positioner 110 and the second valve positioner 120), such that an actuation of the solenoid valve 416 can cause a change in input pressure of the valve actuator 140 for multiple valve positioners. In this way, the solenoid valve 416 can be configured to be actuated, based at least in part on the alert 204 generated by the on-board diagnostic system 404, and cause the input pressure of the valve actuator 140 to be switched from one valve positioner to another valve positioner.

The system 400 can include a valve positioner 402 in communication with the positioner swapping system 410. As can be appreciated, the valve positioner 402 can include any embodiments of the first valve positioner 110 and the second valve positioner 120 discussed herein. In some examples, the valve positioner 402 can be part of a redundant valve positioner system, such that the valve positioner 402 is one of at least two valve positioners including a primary valve positioner and a backup valve positioner. The valve positioner 402 can be in communication with the solenoid valve 416, such that the solenoid valve 416 can be configured to alter a flow path of the pneumatic output from the valve positioner 402. Stated otherwise, the solenoid valve 416 can be configured to be actuated, based at least in part on the alert 406, such that when actuated, the solenoid valve 416 can be configured to redirect an input pressure of the valve actuator 140 from the valve positioner 402 to another valve positioner (e.g., from the first valve positioner 110 to the second valve positioner 120, as discussed herein).

As discussed for individual elements of systems of the disclosed technology, an example implementation of the disclosed technology can include a redundant valve positioner system including a primary valve positioner (e.g., the first valve positioner 110, the first valve positioner 310, the valve positioner 402, etc.), a backup valve positioner (e.g., the second valve positioner 120, the second valve positioner 320, the valve positioner 402, etc.), an on-board diagnostic system (e.g., the first on-board diagnostic system 115, the first on-board diagnostic system 315, the second on-board diagnostic system 125, the second on-board diagnostic system 325, the on-board diagnostic system 404, etc.), and a positioner swapping system (e.g., the positioner swapping system 135, the first positioner swapping system 340, the second positioner swapping system 342, the positioner swapping system 410). The on-board diagnostic system, as discussed for embodiments herein, can be configured to detect a travel deviation of the primary valve positioner (or primary valve) based on a percentage difference between the valve travel of the primary valve positioner and the control signal for the primary valve positioner. As discussed herein, the on-board diagnostic system can be enabled with user defined parameters which determine, at least in part, what can be considered a travel deviation by the on-board diagnostic system. If the on-board diagnostic system detects a travel deviation, the on-board diagnostic system can output an alert signal (e.g., the alert 130, the first alert 330, the alert 406, etc.), to the positioner swapping system. Specifically, the on-board diagnostic system can output an electric signal to an auxiliary switch (e.g., the auxiliary switch 412) configured to automatically open upon receiving the alert signal. The auxiliary switch can in electrical communication with a relay (e.g., the relay 414), such that the auxiliary switch, when opened, can be configured to de-energize the relay 414. Additionally, the relay 414 can be in further electrical communication with a solenoid valve (e.g., the solenoid valve 235, the solenoid valve 416, etc.), such that de-energizing the relay can cause the solenoid valve 416 to be actuated. The solenoid valve 416 can be in fluid communication with the primary valve positioner and the backup valve positioner such that the solenoid valve 416 can be configured to allow and prevent pneumatic outputs of the primary valve positioner and the secondary valve positioner from contributing to an input pressure of a valve actuator (e.g., the valve actuator 140) for a valve (e.g., the valve 150). In this way, the input pressure of the valve actuator can be swapped between the primary valve positioner and the second valve positioner based on whether the alert originated from the primary valve positioner or the backup valve positioner.

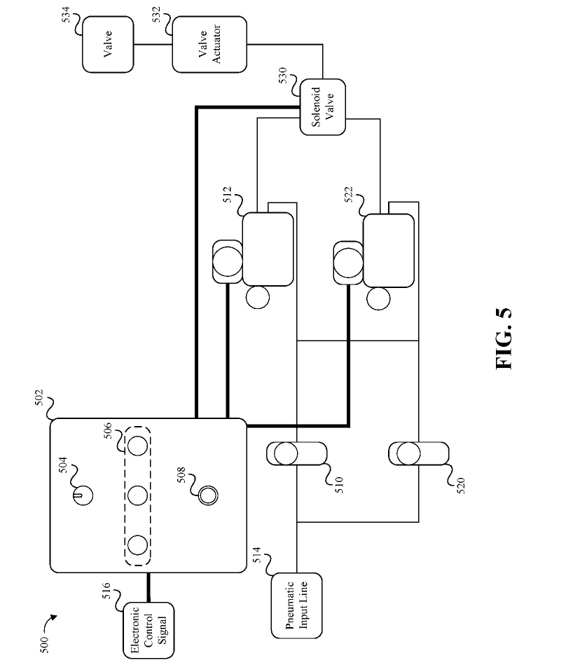

FIG. 5 illustrates a system 500 for mitigating valve-related single point vulnerabilities. The system 500 can be an exemplary embodiment of implementing systems and methods of the disclosed technology. The disclosed technology should not be narrowly construed to include only implementations of the system 500. As can be appreciated, other implementations of the systems and methods disclosed herein may exist.

The system 500 can include a control unit 502 configured to monitor, actuate, and/or interconnect components of the system 500, as will be discussed in greater detail herein. The control unit 502 can include a position selector switch 504 configured to set a mode for the system 500. For example, the position selector switch 504 can include a 3-position selector switch including an “auto” mode, such that in the auto mode the system 500 can be configured to automatically swap from a first valve positioner to a second valve positioner. Similarly, the position selector switch 504 may include a positioner one and/or positioner two setting, such that a user may manually set controlling positioner of a first and second positioner using the position selector switch 504. The control unit 502 can include one or more indicators 506 configured to display conditions of the system 500 and/or indicate (e.g., via color) whether a component of the system 500 is active. For example, an indicator of the one or more indicators 506 can include a positioner one indicator configured to display whether a first valve positioner is functional. In another example, the one or more indicators 506 can include a positioner two indicator configured to display whether a second positioner is on standby. Stated otherwise, the positioner two indicator can convey whether a second positioner is available to be swapped in the event of a failure of a first valve positioner. In some embodiments, the one or more indicators 506 can include a solenoid indicator configured to display whether a solenoid of the system 500 is energized. As discussed herein, whether a solenoid of the system 500 is energized can indicate whether an input pressure of a valve actuator 532 has been successfully swapped from a second valve positioner to a first valve positioner. The control unit 502 can further include a push button 508 configured to reset a relay (e.g., a latching relay or k-relay) of the system 500.

The system 500 can include a first filter regulator 510 configured to control a flow of fluid. The first filter regulator 510 can be in communication with a pneumatic input line 514. Specifically, the first filter regulator 510 can be in fluid communication with the pneumatic input line 514, such that a pneumatic input (e.g., compressed air) may pass through the first filter regulator 510.

The system 500 can include a first valve positioner 512 downstream of the first filter regulator 510. The first valve positioner 512 can include any embodiments of the first valve positioner 110, the first valve positioner 310, and the valve positioner 402 discussed herein. The first valve positioner 512 can be configured to alter a valve travel of a valve 534 via a valve actuator 532. The first valve positioner 512 can be air-operated, such that the first valve positioner 512 can be configured to be opened and/or closed, at least partially, based on an air pressure. That is, the first valve positioner 512 can be configured to generate a pneumatic output by receiving a pneumatic input from the pneumatic input line 514.

The system 500 can include the pneumatic input line 514 configured to supply a pneumatic input to the system 500. In some embodiments, the pneumatic input line 514 can provide air, or pneumatic pressure, such that one or more air-operated valves, or pneumatic elements, may be supplied air via the pneumatic input line 514. For example, if the first valve positioner 512 is an air-operated valve, the pneumatic input line 514 can be in fluid communication with the first valve positioner 512 such that the first valve positioner 512 may be configured to actuate based at least in part on an input fluid from the pneumatic input line 514.

The control unit 502 can be configured to receive an electronic control signal 516. As can be appreciated, the electronic control signal 516 can include embodiments of the control signal 104 discussed herein, such that the electronic control signal 516 can be a received by the control unit 502 from a controller. The electronic control signal 516 can be indicative of a desired valve travel for the valve 534 to be executed by the first valve positioner 512. Stated otherwise, the electronic control signal 516 can include instructions indicative of a percentage (e.g., valve travel) for opening or closing the valve 534 via actuating the valve actuator 532 with the first valve positioner 512. In this way, the control unit 502 can be electrically connected to the first valve positioner 512, such that the control unit 502 can be configured to communicate the electronic control signal 516 to the first valve positioner 512.

The system 500 can include a second filter regulator 520 configured to control a flow of a fluid from the pneumatic input line 514. The second filter regulator 520 can include any embodiments of the first filter regulator 510 discussed herein.

The system 500 can include a second valve positioner 522 downstream of the second filter regulator 520. The second valve positioner 522 can include any embodiments of the second valve positioner 120, the second valve positioner 320, or the valve positioner 402 discussed herein. The second valve positioner 522 can be in fluid communication with the valve actuator 532 for the valve 534 such that the second valve positioner 522 can be configured to alter the valve travel of the valve 534 via the valve actuator 532.

Further, the second valve positioner 522 can be in communication with the pneumatic input line 514, such that if the first valve positioner 512 fails, the second valve positioner 522 can be configured to provide pneumatic output for the input pressure to operate the valve actuator 532. That is, the control unit 502 can be in communication (electrical with the first valve positioner 512 and the second valve positioner 522 such that the control unit 502 can be configured to receive a travel deviation alert (in the form of an alert signal) from on-board diagnostic systems of the first valve positioner 512 and/or the second valve positioner 522 and cause the input pressure for the valve actuator 532 to be the first valve positioner 512, the second valve positioner 522, based at least in part on the travel deviation alert. The electronic control signal 516 can be indicative of a desired valve travel for the valve 534 to be executed by the second valve positioner 522. Stated otherwise, the electronic control signal 516 can include instructions indicative of a percentage (e.g., valve travel) for opening or closing the valve 534 via actuating the valve actuator 532 with the second valve positioner 522. In this way, the control unit 502 can be electrically connected to the second valve positioner 522, such that the control unit 502 can be configured to communicate the electronic control signal 516 to the second valve positioner 522. As discussed herein, the control unit 502 can cause pneumatic output between the first valve positioner 512 and the second valve positioner 522 by swapping an input pressure of the valve actuator 532 between the first valve positioner 512 and the second valve positioner 522. For example, after swapping an input pressure of the valve actuator 532 from the first valve positioner 512 to the second valve positioner 522 and after completion of online maintenance to mitigate travel deviation of the first valve positioner 512, the control unit 502 can make the first valve positioner 512 a controlling valve positioner via swapping the input pressure of the valve actuator 532 from the second valve positioner 522 to the first valve positioner 512.

As shown in FIG. 5, the first valve positioner 512 can be downstream of the first filter regulator 510 and the second filter regulator 520. Similarly, the second valve positioner 522 can be downstream of the first filter regulator 510 and the second filter regulator 520. In this way, both the first filter regulator 510 and the second filter regulator 520 can be configured to supply air pressure to either or both of the first valve positioner 512 and the second valve positioner 522 via instrument valve alignment.

The system 500 can include a solenoid valve 530 configured to swap the input pressure of the valve actuator 532 between the first valve positioner 512 and the second valve positioner 522. That is, as understood herein, the solenoid valve 530 can include any embodiments of the solenoid valve 235 and the solenoid valve 416 discussed herein, such that the solenoid valve 530 can include a solenoid configured to actuate based on an alert received by the solenoid valve 530. As can be appreciated, the alert (e.g., a travel deviation alert) can be in the form of a signal generated by one of the valve positioners and received by the control unit 502, such that the control unit 502 can be configured to output an electrical signal to the solenoid valve 530 indicating whether to actuate. In some embodiments, the control unit 502 can be configured to output pneumatic pressure (e.g., air), to cause the solenoid valve 530 to actuate or de-actuate. The control unit 502, in some embodiments, can include the relay 414 and/or the auxiliary switch 412, such that the control unit 502 can be configured to receive the alert signal at the auxiliary switch 412, which can cause the relay 414 to de-energize which may cause an electrical signal to actuate a solenoid of the solenoid valve 530. As discussed herein, actuating the solenoid valve can include powering the solenoid valve 530, in that the control unit 502 can be configured to cause, at least indirectly, the solenoid valve 530 to be powered. In some embodiments, de-energizing the relay 414 can cause an electrical signal sent to the solenoid valve 530 to cease, thus causing the solenoid valve of the solenoid valve 530 to actuate. Although not shown, the solenoid valve 530 can include one or more isolation (or bypass) valves configured to direct the flow from either positioner to the valve actuator 532. For example, the one or more isolation valves can include three-way bypass instrument valves, as discussed herein.

The system 500 can include the valve actuator 532 configured to operate the valve 534. The valve actuator 532 can include any embodiments of the valve actuator 140 discussed herein, and the valve 534 can include any embodiments of the valve 150 discussed herein. That is, the valve 534 can be a main feedwater regulating valve, for a power plant, such as a nuclear plant. Further, the valve 534 can be an air-operated valve, such that the valve 534 can be configured to open and close, at least partially, based on a pneumatic pressure received by the valve actuator 532. The valve actuator 532, as understood by those skilled in the art, can be configured to operate the valve 534 by receiving compressed air, referred to herein as the input pressure, the input pressure being received in the form of the pneumatic output from at least one of the first valve positioner 512 and the second valve positioner 522.

As shown in FIG. 5, components of the system 500 can be in fluid communication with each other. For example, connections shown in FIG. 5 between any combination of the control unit 502, the first filter regulator 510, the first valve positioner 512, the pneumatic input line 514, the second filter regulator 520, the second valve positioner 522, and the solenoid valve 530 can include a pipe, duct, hose, or similar mechanism understood by those skilled in the art for facilitating fluid communication between at least two elements. Further, the connections between components of the system 500 shown in FIG. 5 can include electrical connections, such that the connections may include any wire, cable, conduit, busbar, or similar mechanism understood by those skilled in the art which enable a transfer of electricity between at least two elements. As shown in FIG. 5, some connections are shown with a thick line, and other connections are shown with a thin line. As a non-limiting example, the thick line connections can indicate an electrical connection, and a thin line connection can indicate a fluid connection, or flow path.

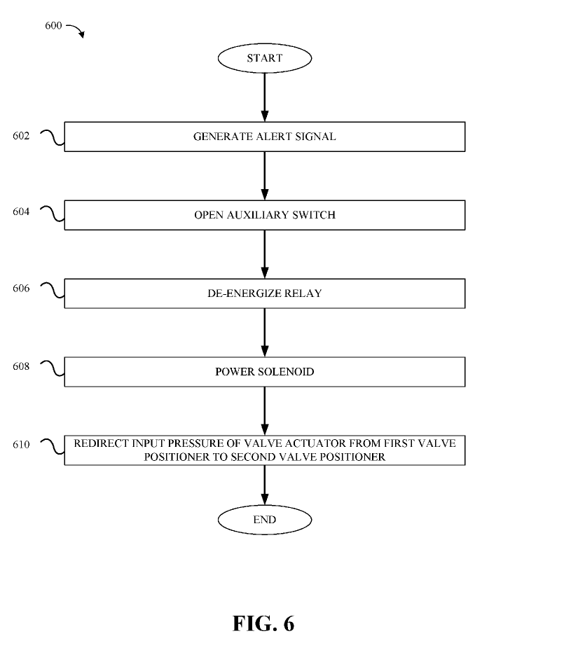

FIG. 6 illustrates a method 600 for mitigating valve-related single point vulnerabilities. The method can include generating 602 an alert signal. As discussed herein, the alert signal can be indicative of a travel deviation of a first valve positioner. Further, the alert signal can be generated by the on-board diagnostic system of the first valve positioner. As can be appreciated, the alert signal can include any embodiments of the alert 130 and the first alert 330 discussed herein, and the first valve positioner can include any embodiments of the first valve positioner 110, the first valve positioner 310, and the first valve positioner 512 discussed herein.

The method 600 can include opening 604 an auxiliary switch. That is, the auxiliary switch, as discussed herein, can be configured to open based on receiving the alert signal. The auxiliary switch can include any embodiments of the auxiliary switch 412 discussed herein. Stated otherwise, the auxiliary switch can be caused to be opened automatically by receiving the alert signal from the on-board diagnostic system of the first valve positioner. That is, the auxiliary switch can be automatically opened if the alert signal is generated by the on-board diagnostic system.

The method 600 can include de-energizing 606 a relay. The relay, as can be appreciated, can include any embodiments of the relay 414 discussed herein. For example, the relay can be a latching relay, such that de-energizing 606 a relay can include de-energizing a coil of a latching relay. The relay can be configured to be de-energized based on a state (or configuration) of the auxiliary switch. That is, the relay can be configured to be de-energized when the auxiliary switch is opened. Stated otherwise, the auxiliary switch can be in communication (electrical and/or mechanical) with the relay, such that the auxiliary switch can cause the latching relay to be de-energized based on the alert signal from an on-board diagnostic system. That is, the relay can be automatically de-energized if the auxiliary switch is opened.

The method 600 can include powering 608 a solenoid. The solenoid can include any embodiments of the solenoid valve 235, solenoid valve 416, and the solenoid valve 530 discussed herein. That is, the solenoid can be powered based on whether the relay is energized. Stated otherwise, the relay can be in communication with the solenoid such that the relay can cause the solenoid to be powered. In this way, the solenoid can be powered based at least in part on the alert signal from the on-board diagnostic system. Embodiments of the solenoid discussed herein referred to the solenoid being actuated, thus, as can be appreciated, powering 608 the solenoid can include actuating the solenoid. In other embodiments, powering 608 the solenoid can include de-actuating (or retracting) the solenoid, as understood by those skilled in the art. That is, the solenoid can be automatically powered if the relay is de-energized.

The method 600 can include redirecting 610 an input pressure of the valve actuator from the first valve positioner to a second valve positioner. The second valve positioner can include any embodiments of the second valve positioner 120, the second valve positioner 320, and the second valve positioner 522 discussed herein. As discussed herein, the first valve positioner and the second valve positioner can be in fluid communication with a valve actuator for a valve, such that the first valve positioner or the second valve positioner can actuate the valve actuator. In this way, the alert signal can indicate an issue with the primary valve positioner, and to avoid a potential failure of the valve actuator and/or the valve, the primary valve positioner can be swapped for the backup valve positioner by making the primary valve positioner a non-controlling valve positioner and making the backup valve positioner a controlling valve positioner. As discussed herein, the valve can be an air operated valve, such that the valve actuator can be driven to open and close the valve based on an input pressure from a pneumatic output from either the first valve positioner or the second valve positioner. In this way, the input pressure received by the valve actuator can be caused to be redirected from the first valve positioner to the second valve positioner due to the alert from the on-board diagnostic system of the first valve positioner. The input pressure of the valve actuator being redirected can include swapping an input source for the input pressure, such that redirecting 610 the input pressure of the valve actuator from the first valve positioner to the second valve positioner can include swapping the input source of the input pressure from the pneumatic output of the first valve positioner to the pneumatic output of the second valve positioner.

Although not shown, the method 600 can further include performing online maintenance on the first valve positioner. As can be appreciated, maintenance can be performed on the first valve positioner after redirecting the input pressure of the valve actuator from the first valve positioner to the second valve positioner. In this way, the maintenance on the first valve positioner can be performed online (without incurring an outage) by automatically causing the input pressure of the valve actuator to be contributed by the pneumatic output of the second valve positioner rather than the first valve positioner. As can be appreciated, the system of the power plant for which the valve operates within can be online while the second valve positioner is controlling, and the first valve positioner is non-controlling. For example, a main feedwater regulating system can be kept online while the first valve positioner is non-controlling (e.g., no pneumatic pressure reaching the valve actuator) and the second valve is controlling (e.g., greater than zero output pneumatic pressure reaching the valve actuator), such that maintenance can be performed on the first valve positioner without bringing the main feedwater regulating system and/or the power plant offline. Maintenance on a valve positioner (e.g., the first valve positioner and/or second valve positioner) discussed herein can include replacement of the valve positioner or any maintenance of valve positioners of similar contexts as understood by those skilled in the art.

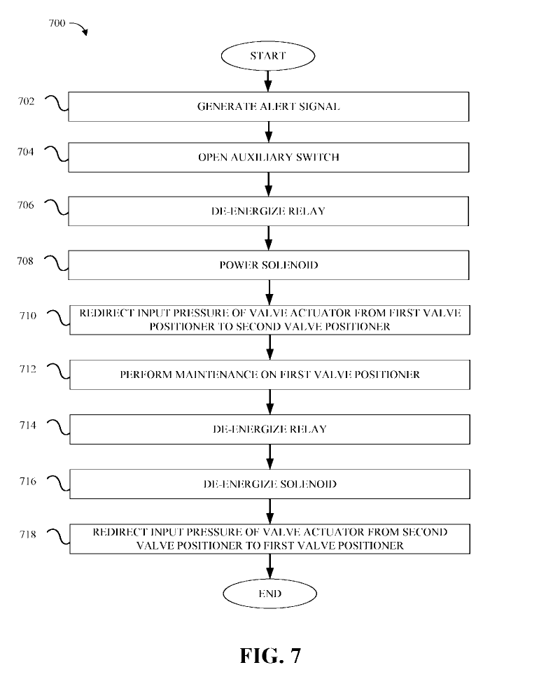

FIG. 7 illustrates a method 700 for mitigating valve-related single point vulnerabilities. As before, the method 700 can include generating 702 an alert signal, and opening 704 an auxiliary switch. The method 700 can include de-energizing 706 a relay. As can be appreciated, the relay can include embodiments of latching relays or k-relays discussed herein, or any relays used for similar contexts as understood by those skilled in the art. In some embodiments, de-energizing 706 the relay can include example methods of de-energizing 606 the latching relay discussed herein. As before, the method can include powering 708 a solenoid and redirecting 710 an input pressure of the valve actuator from a first valve positioner to a second valve positioner.

Additionally, the method 700 can include performing 712 maintenance on the first valve positioner. As can be appreciated, performing 712 maintenance on the first valve positioner can include example methods of performing online maintenance discussed herein. For example, the maintenance on the first valve positioner can include replacing one or more components of the first valve positioner, replacing the first valve positioner with a new valve positioner, etc. The maintenance performed on the first valve positioner can be online, such that the first valve positioner can be maintained or replaced while the coupled valve, valve actuator, and system including the valve are online. As can be appreciated, the first valve positioner can be maintained online due to the second valve positioner being automatically made controlling from the redirecting of the input pressure of the valve actuator.

The method 700 can include de-energizing 714 a relay. The relay can include any embodiments of the relay 414 discussed herein. For example, the relay can be a k-relay configured to cause the input pressure of the valve actuator to be redirected from the second valve positioner to the first valve positioner via a solenoid. That is, the relay, via automatic or manual input, can be caused to be de-energized after maintenance of the first valve positioner is complete. As can be appreciated, de-energizing 714 the relay can include de-energizing a second relay, in that de-energizing 706 the relay can include de-energizing a first relay. In this way, the relay is de-energized to cause the input pressure of the valve actuator to be redirected from the first valve positioner to the second valve positioner can be a separate relay from the relay de-energized to cause the input pressure of the valve actuator to be redirected from the second valve positioner to the first valve positioner.

The method 700 can include de-energizing 716 a solenoid. In some embodiments, the solenoid can be the solenoid or solenoid valve configured to redirect the input pressure of the valve actuator from the first valve positioner to the second valve positioner. As can be appreciated, de-energizing the solenoid can effectively be the reverse process of energizing the solenoid and/or solenoid valve. In this way, de-energizing the solenoid and/or the solenoid valve can be configured to cause the input pressure of the valve actuator to be redirected back to the first valve positioner from the second valve positioner. In a non-limiting example, the solenoid can be configured to direct a pneumatic output of the first valve positioner to a valve actuator in a powered, or energized, state, and can be configured to direct a pneumatic output of the second valve positioner to the valve actuator in an unpowered, or de-energized, state.

The method 700 can include redirecting 718 the input pressure of the valve actuator from the second valve positioner to the first valve positioner. As discussed herein, the input pressure of the valve actuator can be caused to be redirected from being supplied by the second valve positioner to the first valve positioner based at least in part on an actuation of the relay and the solenoid. Stated otherwise, causing the relay to be de-energized can cause the solenoid to be de-energized which can cause, automatically, the input pressure of the valve actuator to be supplied by the pneumatic output of the first valve positioner rather than the pneumatic output of the second valve positioner. As discussed herein, the input pressure of the valve actuator being redirected can include swapping an input source for the input pressure, such that redirecting 718 the input pressure of the valve actuator from the second valve positioner to the first valve positioner can include swapping the input source of the input pressure of the valve actuator from the pneumatic output of the second valve positioner to the pneumatic output of the first valve positioner

The methods just described are offered for explanatory purposes and should not be construed as limited to the particular steps and order of steps just described. That is, the methods just described can include other intervening steps not described or the methods can be completed in an order other than described herein. Accordingly, the methods should be understood in the context of the entire disclosure presented herein.

The disclosed technology can be further understood according to the following clauses:
Clause 1: A system for mitigating valve-related single point vulnerabilities comprising: a first valve positioner connected to a valve actuator of a valve, the first valve positioner comprising an on-board diagnostic system configured to generate an alert; a second valve positioner connected to the valve actuator; and a positioner swapping system configured to redirect an input pressure of the valve actuator from the first valve positioner to the second valve positioner based at least in part on the alert.
Clause 2: The system of Clause 1, wherein the alert is a travel deviation alert indicative of a travel deviation of the first valve positioner.
Clause 3: The system of Clause 1, wherein the positioner swapping system comprises a solenoid valve configured to automatically redirect the input pressure from the first valve positioner to the second valve positioner based at least in part on the alert.
Clause 4: The system of Clause 3, wherein the positioner swapping system further comprises an auxiliary switch electrically connected to the on-board diagnostic system, the on-board diagnostic system being configured to automatically open the auxiliary switch based at least in part on the alert.
Clause 5: The system of Clause 4, wherein the positioner swapping system further comprises a relay electrically connected to the auxiliary switch, the auxiliary switch being configured to de-energize the relay based at least in part on the alert.
Clause 6: The system of Clause 5, wherein the relay is configured to power the solenoid valve based at least in part on a state of the relay, the solenoid valve being further configured to redirect the input pressure from the first valve positioner to the second valve positioner.
Clause 7: The system of Clause 3, wherein the alert includes an alert signal configured to automatically cause an auxiliary switch to open, the auxiliary switch being configured to automatically cause a relay to de-energize if opened, the relay being configured to cause the solenoid valve to redirect the input pressure from the first valve positioner to the second valve positioner if de-energized.
Clause 8: The system of Clause 1, wherein the valve is an air-operated valve.
Clause 9: The system of Clause 8, wherein the valve is a main feedwater regulating valve of a nuclear power plant.
Clause 10: A system for mitigating valve-related single point vulnerabilities comprising: a valve actuator configured to operate a valve; a first valve positioner connected to the valve actuator and configured to alter valve travel of the valve, the first valve positioner comprising a first on-board diagnostic system configured to generate a first alert; a second valve positioner connected to the valve actuator and configured to alter valve travel of the valve, the second valve positioner comprising a second on-board diagnostic system configured to generate a second alert; and a positioner swapping system comprising a solenoid valve configured to swap an input pressure of the valve actuator from the first valve positioner to the second valve positioner based at least in part on at least one of the first alert and the second alert.
Clause 11: The system of Clause 10, wherein the positioner swapping system further comprises: an auxiliary switch configured to receive the first alert and the second alert and open upon receipt of at least one of the first alert and the second alert; and a relay configured to open based at least in part on whether the auxiliary switch is open.
Clause 12: The system of Clause 11, wherein the relay is further configured to open if the auxiliary switch is open, the solenoid valve is further configured to actuate if the relay is open.
Clause 13: The system of Clause 10, wherein the valve is an air-operated valve.
Clause 14: A method for mitigating valve-related single point vulnerabilities comprising: generating an alert signal from an on-board diagnostic system of one of a primary valve positioner and a backup valve positioner, the primary valve positioner and the backup valve positioner being connected to a valve actuator of a valve; and redirecting an input pressure of the valve actuator from one of the primary valve positioner and the backup valve positioner to the other of the primary valve positioner and the backup valve positioner based at least in part on the alert signal.
Clause 15: The method of Clause 14, wherein generating the alert signal from the on-board diagnostic system of one of the primary valve positioner and the backup valve positioner comprises: monitoring a control signal and a valve travel of the valve; and detecting a travel deviation based at least in part on the control signal and the valve travel.
Clause 16: The method of Clause 15, wherein redirecting the input pressure one of the primary valve positioner and the backup valve positioner to the other of the primary valve positioner and the backup valve positioner comprises causing an auxiliary switch to open based at least in part on the alert signal.
Clause 17: The method of Clause 16, wherein redirecting the input pressure of the valve actuator from one of the primary valve positioner and the backup valve positioner to the other of the primary valve positioner and the backup valve positioner further comprises: de-energizing a relay; and powering a solenoid valve, causing the input pressure to be redirected from one of the primary valve positioner and the backup valve positioner to the other of the primary valve positioner and the backup valve positioner.
Clause 18: The method of Clause 14, wherein redirecting the input pressure of the valve actuator from one of the primary valve positioner and the backup valve positioner to the other of the primary valve positioner and the backup valve positioner comprises redirecting the input pressure from the primary valve positioner to the backup valve positioner.
Clause 19: The method of Clause 18, further comprising performing online maintenance on the valve.
Clause 20: The method of Clause 19, further comprising redirecting the input pressure from the backup valve positioner to the primary valve positioner.

While the present disclosure has been described in connection with a plurality of exemplary aspects, as illustrated in the various figures and discussed above, it is understood that other similar aspects can be used, or modifications and additions can be made to the described subject matter for performing the same function of the present disclosure without deviating therefrom. In this disclosure, methods and compositions were described according to aspects of the presently disclosed subject matter. But other equivalent methods or compositions to these described aspects are also contemplated by the teachings herein. Therefore, the present disclosure should not be limited to any single aspect, but rather construed in breadth and scope in accordance with the appended claims.

What is claimed is:

1. A system for mitigating valve-related single point vulnerabilities comprising:
a first valve positioner connected to a valve actuator of a valve, the first valve positioner comprising an on-board diagnostic system configured to generate an alert;
a second valve positioner connected to the valve actuator; and
a positioner swapping system configured to redirect an input pressure of the valve actuator from the first valve positioner to the second valve positioner based at least in part on the alert.

2. The system of claim 1, wherein the alert is a travel deviation alert indicative of a travel deviation of the first valve positioner.

3. The system of claim 1, wherein the positioner swapping system comprises a solenoid valve configured to automatically redirect the input pressure from the first valve positioner to the second valve positioner based at least in part on the alert.

4. The system of claim 3, wherein the positioner swapping system further comprises an auxiliary switch electrically connected to the on-board diagnostic system, the on-board diagnostic system being configured to automatically open the auxiliary switch based at least in part on the alert.

5. The system of claim 4, wherein the positioner swapping system further comprises a relay electrically connected to the auxiliary switch, the auxiliary switch being configured to de-energize the relay based at least in part on the alert.

6. The system of claim 5, wherein the relay is configured to power the solenoid valve based at least in part on a state of the relay, the solenoid valve being further configured to redirect the input pressure from the first valve positioner to the second valve positioner.

7. The system of claim 3, wherein the alert includes an alert signal configured to automatically cause an auxiliary switch to open, the auxiliary switch being configured to automatically cause a relay to de-energize if opened, the relay being configured to cause the solenoid valve to redirect the input pressure from the first valve positioner to the second valve positioner if de-energized.

8. The system of claim 1, wherein the valve is an air-operated valve.

9. The system of claim 8, wherein the valve is a main feedwater regulating valve of a nuclear power plant.

10. A system for mitigating valve-related single point vulnerabilities comprising:
a valve actuator configured to operate a valve;
a first valve positioner connected to the valve actuator and configured to alter valve travel of the valve, the first valve positioner comprising a first on-board diagnostic system configured to generate a first alert;
a second valve positioner connected to the valve actuator and configured to alter valve travel of the valve, the second valve positioner comprising a second on-board diagnostic system configured to generate a second alert; and
a positioner swapping system comprising a solenoid valve configured to swap an input pressure of the valve actuator from the first valve positioner to the second valve positioner based at least in part on at least one of the first alert and the second alert.

11. The system of claim 10, wherein the positioner swapping system further comprises:
an auxiliary switch configured to receive the first alert and the second alert and open upon receipt of at least one of the first alert and the second alert; and
a relay configured to open based at least in part on whether the auxiliary switch is open.

12. The system of claim 11, wherein the relay is further configured to open if the auxiliary switch is open, the solenoid valve is further configured to actuate if the relay is open.

13. The system of claim 10, wherein the valve is an air-operated valve.

14. A method for mitigating valve-related single point vulnerabilities comprising:
generating an alert signal from an on-board diagnostic system of one of a primary valve positioner and a backup valve positioner, the primary valve positioner and the backup valve positioner being connected to a valve actuator of a valve; and
redirecting an input pressure of the valve actuator from one of the primary valve positioner and the backup valve positioner to the other of the primary valve positioner and the backup valve positioner based at least in part on the alert signal.

15. The method of claim 14, wherein generating the alert signal from the on-board diagnostic system of one of the primary valve positioner and the backup valve positioner comprises:
monitoring a control signal and a valve travel of the valve; and
detecting a travel deviation based at least in part on the control signal and the valve travel.

16. The method of claim 15, wherein redirecting the input pressure one of the primary valve positioner and the backup valve positioner to the other of the primary valve positioner and the backup valve positioner comprises causing an auxiliary switch to open based at least in part on the alert signal.

17. The method of claim 16, wherein redirecting the input pressure of the valve actuator from one of the primary valve positioner and the backup valve positioner to the other of the primary valve positioner and the backup valve positioner further comprises:
de-energizing a relay; and
powering a solenoid valve, causing the input pressure to be redirected from one of the primary valve positioner and the backup valve positioner to the other of the primary valve positioner and the backup valve positioner.

18. The method of claim 14, wherein redirecting the input pressure of the valve actuator from one of the primary valve positioner and the backup valve positioner to the other of the primary valve positioner and the backup valve positioner comprises redirecting the input pressure from the primary valve positioner to the backup valve positioner.

19. The method of claim 18, further comprising performing online maintenance on the valve.

20. The method of claim 19, further comprising redirecting the input pressure from the backup valve positioner to the primary valve positioner.
